(19) United States
(12) Patent Application Publication
(10) Pub. No.: US 2005/0109923 A1
(43) Pub. Date: May 26, 2005

(54) Optical assembly with variable optical attenuator

(75) Inventors: Ryan Hickey, Ontario (CA); Christopher Hart, Ontario (CA); James Wilde, Allen, TX (US); Heiko Fettig, Quebec (CA)

Correspondence Address: LAUBSCHER SEVERSON, 1160 SPA RD, SUITE 2B, ANNAPOLIS, MD, 21403, US

(73) Assignee: Bookham Technology PLC, Abingdon (GB)

(21) Appl. No.: 10/974,532

(22) Filed: Oct. 27, 2004

Related U.S. Application Data
(60) Provisional application No. 60/514,014, filed on Oct. 27, 2003.

(51) Int. Cl. G01J 1/20

(52) U.S. Cl. 250/227.21

(57) ABSTRACT

An optical assembly includes a photodetector for detecting light signals. An optical fiber receives an input signal and has a light-emitting portion extending in front of the photodetector. A MEMS actuator is located between the light-emitting portion of the optical fiber and the photodetector. The MEMS actuator is controllably deflectable to partially obscure the photodetector and thereby vary the amount of light received.

### CROSS REFERENCE TO RELATED APPLICATION

This application claims the benefit under 35 USC 119(e) of prior U.S. provisional application Ser. No. 60/514,014 filed Oct. 27, 2003, the contents of which are herein incorporated by reference.

### FIELD OF THE INVENTION

This invention relates to the field of photonics, and in particular to an optical assembly including a variable optical attenuator for selectively attenuating an optical signal introduced into an optoelectronic package via an optical fiber and converted to an electrical signal by a photodetector.

### BACKGROUND OF THE INVENTION

Variable optical attenuators are used in optical fiber technology for various purposes. For example, one application is to adjust the intensity of a received or transmitted signal so that it best matches the operational range of the optical signal receiver. In this invention, the attenuator also serves to protect the photodetector from damage due to high optical inputs. One such attenuator is described in U.S. Pat. No. 6,066,844, the contents of which are herein incorporated by reference. This solid state device employs membrane technology, which among other things does not permit complete attenuation of the signal. The solid state device can be expensive to make.

Another type of variable optical attenuator with a profiled blade is described in U.S. Pat. No. 6,246,826 the contents of which are herein incorporated by reference. It includes a mounting base with an actuator formed on the base, the actuator carrying the blade which is moveable across a light beam. The blade is profiled so as to provide a predetermined attenuation of the beam as a function of the displacement of the blade. The blade includes a pattern consisting of a three dimensional notch or protrusion selected to achieve a predetermined attenuation function. This device is of complex construction and also difficult to make.

### SUMMARY OF THE INVENTION

The invention employs MEMS (Micro-Electromechanical Systems) technology to provide an effective, easily manufacturable module with a wide dynamic range.

According to the present invention there is provided an optical MEMS assembly for controlling the amount of light received by a photodetector, said optical assembly being locatable over said photodetector and comprising an optical transmission medium for receiving an input signal and having a light-emitting portion for directing light toward said photodetector; a controllably deflectable actuator; and a light-obscuring member mounted on said actuator for at least partially obscuring said photodetector from said light-emitting portion depending on the deflection state of said actuator arm.

A novel aspect of this invention is that all components are co-packaged into a single optoelectronic package.

The optical transmission medium is typically an optical fiber, although the invention is similarly applicable when the optical input is presented to the photodetector from the system fiber by a lens-train design, for example.

The optical fiber, which preferably extends transversely in front of the photodetector, can be cleaved at an angle at one end to deflect light onto the photodetector. Typically, this angle will be close to 45° so that light passing along the optical fiber will be reflected off the internal end surface directly onto the photodetector. The optical signal can also be presented to the photodetector in the current configuration via a beam splitter rather than the angled fiber, or can be packaged such that a straight cleave fiber or other lens arrangement could be used, e.g. mounting the variable optical attenuator and photodetector vertically.

The photodetector can be integrated into a common substrate with the MEMS actuator.

The invention also provides a method of controlling the amount of light received by a photodetector, comprising directing a received input signal toward a photodetector; and displacing a light-obscuring member mounted on a MEMS actuator to at least partially obscure said photodetector.

### BRIEF DESCRIPTION OF THE DRAWINGS

The invention will now be described in more detail, by way of example only, with reference to the accompanying drawings, in which:—

FIG. 1 is a perspective view of one embodiment of an optical assembly in accordance with the invention; and

FIG. 2 is a more detailed view of the region around the photodetector.

### DETAILED DESCRIPTION OF THE PREFERRED EMBODIMENTS

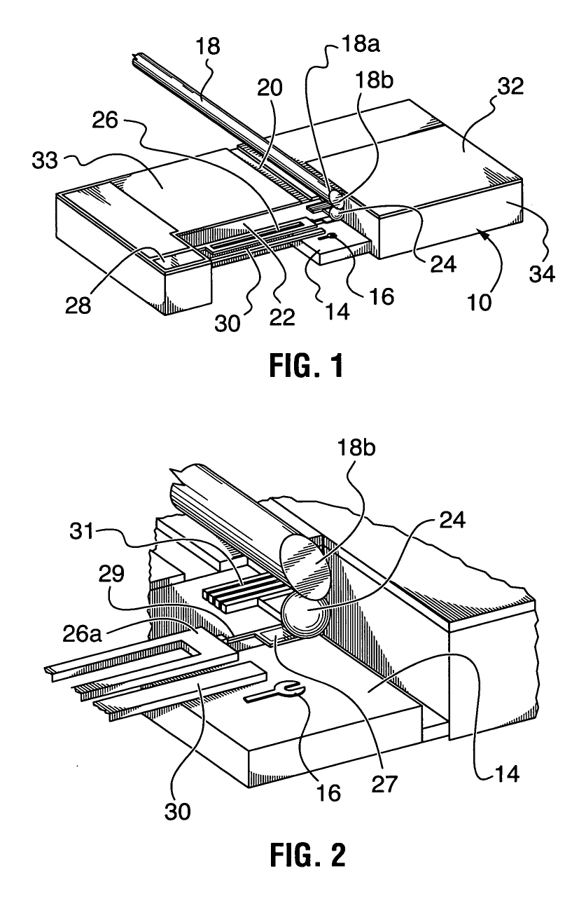

The optical assembly, forming a VOA (Variable Optical Attenuator) shown in FIGS. 1 and 2 forms a sub-assembly that is designed to sit over a photodetector 16 forming part of a detector assembly 14 for incoming signals transmitted over an optical fiber or other optical transmission medium. The VOA comprises a rectangular substrate 10, which can be silicon-on-insulator material, or single crystal silicon. The substrate includes on its top surface a landing pad 33 and a capacitor pad 32.

A rectangular recess 12 is formed in one of the long sides of the rectangular substrate 10. This allows for the VOA to sit atop the detector assembly 14 in a saddle configuration.

The photodetector 16 can be any suitable photodetector for optical communications, for example, a PIN photodetector or an avalanche photodetector (APD).

An optical fiber 18 is mounted in a V-groove 20 formed on the top surface of the substrate 10. The V-groove 20 serves to accurately align the optical fiber 18 with the photodetector 16.

The optical fiber 18 has an end portion 18a that protrudes beyond the end wall 22 of the recess 12. The end portion 18a terminates in a cleaved end 18b angled at 45° lying over the photodetector 16. Light traveling along the optical fiber 18 is reflected by total internal reflection off the end face of the cleaved end 18b and directed downwards toward the photodetector 16.

Optional balls lens 24 mounted at the end of the optical fiber 18 focuses light onto the photodetector 16.

The other end of the optical fiber 18 has a coupling (not shown) for connection to an external communications optical fiber.

A cantilevered MEMS actuator arm 26, which can be made of silicon, is mounted at one end 28 thereof on the substrate 10. However, the actuator arm 26 could also be made of other suitable materials. The cantilevered arm 26 is thermally actuated and could be of the type described in our co-pending provisional application Ser. No. 60/320,089, the contents of which are herein incorporated by reference. As described in our co-pending application, the actuator arm 26 is mounted alongside a heat sink 30. The arm is deflected by passing a current through it. The current produces differential heating of the two segments of the arm, which causes the arm to deflect toward the heat sink 30.

As better seen in FIG. 2, the tip 26a of the actuator arm 26 is connected by a bridging link 29 to an opaque rectangular member 27, referred to as a paddle, which is normally clear of the photodetector 16. As the arm 26 deflects, the paddle 27 gradually moves under the end 18b of the optical fiber 18 and blocks progressively more light from reaching the photodetector 16 as the amount of deflection of the actuator arm 26 increases. It will be appreciated that the shape of the paddle is not critical so long as it is capable of selectively obscuring the photodetector as the actuator arm is displaced. A paddle in this context is a generally flat, blade-like device. Although the opaque member will generally be flat, it could have any solid shape, and need not necessarily be completely opaque so long as it is capable of reducing the amount of light passing through it. Alternatively, the paddle can normally block the light from reaching the photodetector and progressively expose the photodetector as the actuator arm 26 deflects.

The paddle 27 is also connected to a concertinaed spring element 31, which permits current to be supplied to one end of the actuator arm 26 through the paddle 27 while allowing deflection of the actuator arm 26. As the paddle moves in a direction toward the end of the optical fiber 18, the concertinaed spring element 31 resiliently expands.

The actuator arm 26 can also act as a shutter allowing the light to be completely blocked if desired.

Element 32 is a capacitor pad. If desired, control circuits for the optical assembly can be integrated into the portion 34 of the silicon substrate below the capacitor pad 32 using conventional integrated circuit fabrication technology.

The described device has several advantages over prior art constructions. The variable optical attenuator is planar with the floor of the package. The device can sit directly over the receiver in a saddle-like configuration. It can also use a large chip to facilitate packaging. The use of a paddle shape facilitates wire bonding to the photodetector or any optoelectronics dice placed below the VOA. The device can also act as a jumper chip between other devices.

The device has zero insertion loss since in the normal position it is completely open. The actuator arm is not located in the light path between the optical fiber and the photodetector. The device also allows control of the overload limit of any co-packaged electronics. An example is the amplifier following the photodetector in this embodiment.

A typical device has a minimum of 50 μm travel for the end of the actuator arm, 12 V maximum shutter drive, zero insertion loss when the actuator is not powered, and a minimum of 25 dB attenuation range.

However, these values can be changed by changes to the starting material properties, without changing the nature of the invention described.

It will be understood by those skilled in the art that the components can be fabricated using MEMS fabrication techniques known in the art.

The embodiments presented are exemplary only and persons skilled in the art would appreciate that variations to the above described embodiments may be made without departing from the spirit of the invention. The scope of the invention is solely defined by the appended claims.

1. An optical MEMS assembly for controlling the amount of light received by a photodetector, said optical assembly being locatable over said photodetector and comprising:
an optical transmission medium for receiving an input signal and having a light-emitting portion for directing light toward said photodetector;
a controllably deflectable actuator; and
a light-obscuring member mounted on said actuator for at least partially obscuring said photodetector from said light-emitting portion depending on the deflection state of said actuator arm.

2. The optical assembly of claim 1, wherein said light-obscuring member is a paddle.

3. The optical assembly of claim 1, wherein said optical transmission medium is an optical fiber.

4. The optical assembly of claim 3, wherein said optical fiber extends transversely in front of said photodetector and said light-emitting portion comprises a cleaved portion to direct light onto said photodetector.

5. The optical assembly of claim 4, wherein said cleaved portion comprises an angled cleaved end portion.

6. The optical assembly of claim 5, further comprising a lens between said angled cleaved end portion and said photodetector.

7. The optical assembly of claim 6, wherein said lens is a ball lens.

8. The optical assembly of claim 7, wherein said actuator comprises a cantilevered arm supported at one end on a substrate and extending over a recess in said substrate.

9. The optical assembly of claim 8, wherein said photodetector is locatable within said recess in said substrate.

10. The optical assembly of claim 3, wherein said optical fiber is supported in an alignment groove on said substrate.

11. The optical assembly of claim 10, wherein said alignment groove is a V-shaped groove.

12. The optical assembly of claim 1, wherein said light-obscuring member is arranged to progressively obscure said photodetector as said actuator is deflected.

13. The optical assembly of claim 1, wherein said light-obscuring member is arranged to progressively expose said photodetector as said actuator is deflected.

14. The optical assembly of claim 1, wherein said light-obscuring member is also connected to a concertinaed spring element to allow current to be supplied to said actuator.

15. A method of controlling the amount of light received by a photodetector, comprising:
directing a received input signal toward a photodetector; and
displacing a light-obscuring member mounted on a MEMS actuator to at least partially obscure said photodetector.

16. The method of claim 15, wherein said actuator is deflected to obscure said photodetector.

17. The method of claim 16, wherein said actuator is deflected to expose said photodetector.

18. The method of claim 15, wherein said input signal is direct toward said photodetector from a cleaved end of an optical fiber.

19. The method of claim 18, wherein said input signal is further passed through a ball lens focusing said input signal onto said photodetector.

20. An optical MEMS assembly for controlling the amount of light received by a photodetector, said optical assembly being locatable over said photodetector and comprising:
means for receiving an input signal and having a light-emitting portion for directing light toward said photodetector;
a controllably deflectable actuator; and
means mounted on said actuator for at least partially obscuring said photodetector from said light-emitting portion depending on the deflection state of said actuator arm.

21. The optical assembly of claim 20, wherein said actuator comprises a cantilevered actuator arm.
